(19) United States
(12) Patent Application Publication
(10) Pub. No.: US 2012/0027251 A1
(43) Pub. Date: Feb. 2, 2012

(54) DEVICE WITH MARKINGS FOR CONFIGURATION

(76) Inventors: Wei Wu, Palo Alto, CA (US); R. Stanley Williams, Portola Valley, CA (US)

(21) Appl. No.: 12/847,395

(22) Filed: Jul. 30, 2010

(51) Int. Cl. G06K 9/00; G01B 11/14; G01C 9/00

(52) U.S. Cl. 382/103; 356/138; 356/614

(57) ABSTRACT

A device including a network interface is marked for determination of the position or orientation of the device. In particular, the markings can include a pattern and proportions that enable determination of at least one of a position and an orientation of the device relative to a station using appearance of the markings as observed from the station.

### BACKGROUND

The Central Nervous System for the Earth (CeNSE) project announced by Hewlett-Packard Laboratories envisions embedding devices such as sensors or actuators throughout large areas and connecting these devices to storage and computing systems via an array of networks. The devices can provide a tremendous amount of data that analysis engines, storage systems, and end users could employ in ways that could revolutionize human interaction with the Earth. For example, just a few of the potential uses of the CeNSE system include: monitoring environmental conditions such as weather, pollution, and wildlife activity; monitoring and mapping subterranean features such as mineral deposits, monitoring fault lines and providing advance warnings of earthquakes; monitoring roads and highway to detect traffic levels, accidents, road conditions; and maintenance issues; and tracking commerce and the movement of goods. Processing of the data from such sensors will often require information concerning the position (e.g., latitude, longitude, and altitude) of each device to identify the location of each measurement or action and the orientation (e.g., pitch, yaw, and roll angles) of each device to identify a direction associated with a measurement or effect. With a large number of sensors deployed in the field, e.g., up to a trillion worldwide and perhaps a million or more in each network area, identifying all of the deployed devices and measuring their respective locations and orientations of the devices can be a daunting task, particularly because such measurements may need to be repeated periodically to identify changes. Manual measurements of the positions and orientations of the devices in the CeNSE system may be impractical.

The problem of identifying and measuring the position and/or orientation devices, objects, or individuals in the field is not unique to the CeNSE system. For example, locating the positions and headings of equipment and personnel in the field may be useful for businesses or the military. However, the measurement precision required and the number of separate devices deployed for the CeNSE system may place greater demands on in the field configuration processes than encountered in most other applications. Systems and methods for identifying and measuring the configurations of large numbers of objects are thus desired.

### BRIEF DESCRIPTION OF THE DRAWINGS

FIG. 1 illustrates an embodiment of the invention in which devices in a network are arranged within the respective observation areas of multiple towers.

FIG. 2A shows a device marked in accordance with an embodiment of the invention.

FIG. 2B shows an observation station in accordance with an embodiment of the invention.

FIG. 3 is a flow diagram of a process in accordance with an embodiment of the invention in which a station captures images of markings on devices.

FIG. 4 is a flow diagram of a process in accordance with an embodiment of the invention in which images of devices are processed to determine the positions and orientations of the devices.

FIG. 5 shows an embodiment of the invention in which a surface of a device is marked for remote determination of the identity, the position, and the orientation of the device.

FIG. 6 illustrates the appearance of the surface of FIG. 5 when imaged from a camera angle that is not perpendicular to the surface.

Use of the same reference symbols in different figures indicates similar or identical items.

### DETAILED DESCRIPTION

In accordance with an aspect of the present invention, devices can be marked for automated determination of the identities, the locations, and the orientations of the devices when deployed. In one particular embodiment, the devices are networked devices having markings that are observed or measured from towers or stations that may also be employed for network communications with the devices. The markings on a device can include a unique coded marking, directional markings, or measured markings that can be used to determine the identity, position, and orientation of the device. The markings can be formed with reflective tape, retroreflective tape, retroreflectors, or other systems for marking that provide sufficient contrast or reflectivity for imaging at a distance. Through use of remotely observed markings, the configuration of a large number of devices can be determined at a low cost, particularly when compared to the cost of providing position and orientation measuring system in each device.

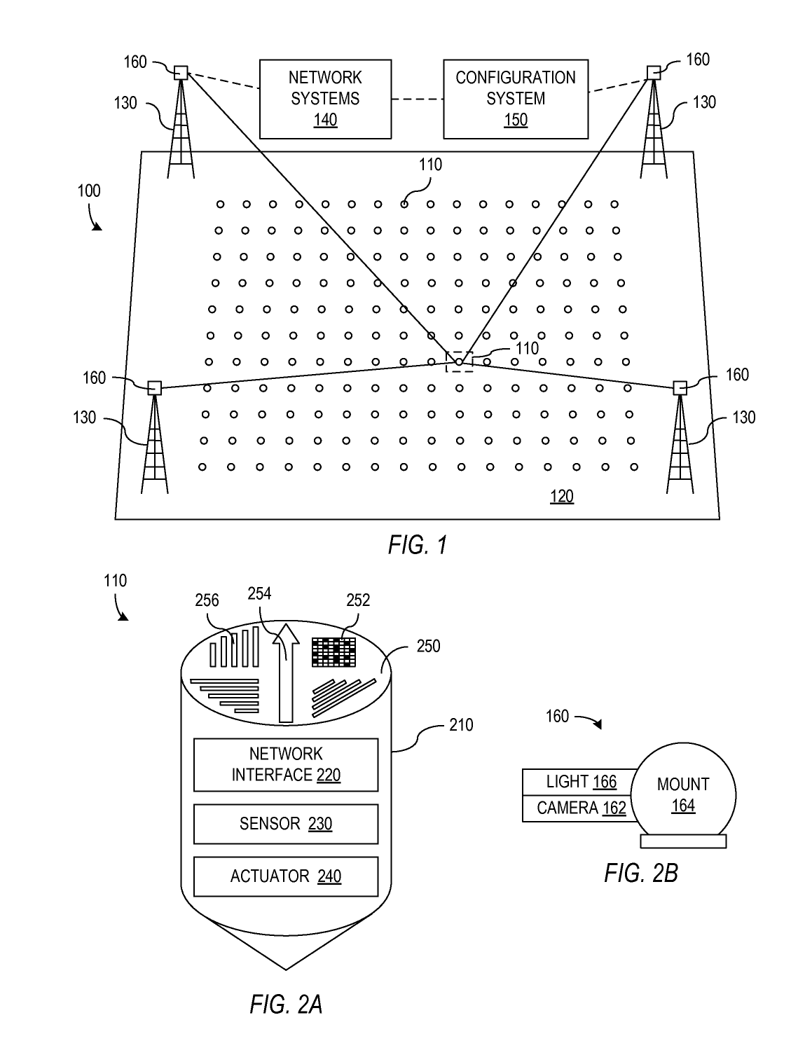

FIG. 1 illustrates a system 100 in which devices 110 are deployed over an area 120. Devices 110 may, for example, be implanted outdoors in the ground or on the exterior of structures. For example, devices 110 may be deployed in an array spread over many acres or even square miles of land for monitoring of the environmental or subterranean conditions. Alternatively, devices 110 may be installed at intervals (e.g., about 10 m apart) along a roadway, bridge, overpass, or railway, or devices 110 could be embedded in a structure such as a building or a dam. Devices 110 in FIG. 1 are network devices that can communicate over a wireless network including wireless hubs or other network equipment mounted on towers 130. Other network systems 140, which may be local or remote from towers 130, can communicate with towers 130 either through a wireless network or through wire or fiber connections. Network systems 140 can include systems such as computers executing software for processing information received from or sent to devices 110 and data storage for storage of information from devices 110. Network systems 140 may also include a bridge to one or more public networks such as the Internet, so that information from devices 110 is widely accessible. System 100 in one embodiment is a portion of a Central Nervous System of the Earth (CeNSE) of Hewlett-Packard Company.

FIG. 2A shows an exemplary embodiment of one of the devices 110. In the embodiment of FIG. 2A, device 110 includes a housing 210 containing a network interface 220, a sensor 230, an actuator 240, and a power source (not shown) such as a battery or a photovoltaic cell. Housing 210 can be any structure that sufficiently protects network interface 220, sensor 230, and actuator 240 from the environment when device 110 is deployed. For example, housing 110 may be the packaging of a chip containing network interface 220, sensor 230, and actuator 240 or a separate enclosure from network interface 220, sensor 230, and actuator 240. Network interface 220 implements a wireless network communication protocol such as WiFi, WiMAX, or any other standard or proprietary network protocol. Accordingly, devices 110 can communicate with towers 130 of FIG. 1 using network communication techniques. Sensor 230 measures or senses one or more quantities or conditions and can transmit resulting measurement data through network interface 220. Some examples of sensors that may be used in embodiments of device 110 include but are not limited to: accelerometers that measure acceleration or vibration; light sensors that measure broad or narrow bands of electromagnetic radiation; magnetic sensors; radiation sensors that detect particular types of radiation, radiation rates, or accumulated radiation doses, and chemical sensors that detect the presence or concentration of one or more chemicals or class of chemicals in the environment surrounding device 110. Actuator 240 can be any device capable of acting in response to a command, which may be received through network interface 220. Some examples of actuators that may be used in embodiments of device 110 include: a thumper that acts to create ground vibrations, an ultrasounds speaker, or even an explosive charge that can be triggered to produce shock wave that can be sensed by other devices 110. Sensor 230 and actuator 240 are shown in device 110 to illustrate a general example, but one or the other of sensor 230 or actuator 240 may be omitted in some embodiments of the invention.

Device 110 has a surface 250 with markings 252, 254, and 256 that may be positioned to be visible when device 110 is deployed. Surface 250 may, for example, be a planar, top surface of housing 210. The size and shape of surface 250 will generally vary for different embodiments of device 110, but in one embodiment, surface 250 may be on the order or 1 cm to 10 cm across. In some other embodiments, device 110 may be an integrated circuit chip, and surface 250 may be the size of a chip or of chip packaging. Markings 252, 254, and 256 in the illustrated embodiment include a coded or identifier portion 252, a directional or asymmetric portion 254, and a measured or regularly-spaced portion 256, which can be used to identify the device 110 and to determine the position and orientation of device 110 relative to an observation system. Markings 252, 254, and 256 can be printed on surface 250 or attached to surface 250 using an appliqué or tape. In one specific embodiment, markings 252, 254, and 256 are formed using reflective tape or retroreflectors. Coded marking 252 identify a specific device 110, for example, by indicating a unique identification number associated with the device 110. Coded marking 252 may, for example, be a linear arrangement of regions as in a bar code or two-dimensional arrangement of contrasting regions that are positioned to indicate the identity of device 110. Directional markings 254 have an asymmetry that identifies a specific direction on device 110. For example, directional marking 254 may be oriented on surface 250 to indicate the direction of a specific measurement axis of sensor 230 when device 110 contains a sensor 230 that measures a vector quantity such as acceleration. Directional marking 254 could similarly be oriented to indicate the direction of an effect of actuator 240 when device 110 contains an actuator 240 having a direction dependent action. In FIG. 2A, directional marking 254 is an arrow but many other asymmetric patterns could be employed. Measured markings 256 have dimensions that are measured and provide a distance scale for images or observations of surface 250 and have known proportions to allow determination of the tilt of surface 250 relative to a view direction. Measured markings 256 may, for example, have a known spacing between features such as lines of marking 256 or known widths, lengths, or sizes of features of markings 256. In FIG. 2A, measured markings 256 include sets of parallel stripes oriented in different directions, where both the width of the stripes and the separation of the stripes can be pre-measured and known to a configuration system.

FIG. 2A shows separate markings 252, 254, and 256 as being coded, directional, and measured markings, but some embodiments of the invention can employ combined markings having the properties of two or more of the coded, directional, and measured markings 252, 254, and 256. For example, the size of a coded marking or a directional marking can be measured to provide a scale for images or observations of a device 110. Also, directional markings can be achieved through an asymmetric arrangement of the coded or measured markings Other combinations are possible.

Devices 110 in FIG. 1 generally can be of the same type or of different types depending on the function or functions to be served. For example, all of devices 110 can contain sensors 230 that are similar or identical accelerometers for monitoring of vibrations across field 120. Alternatively, other types of devices 110 containing other types of sensors (e.g., temperature sensors) or containing actuators (e.g., thumpers) may be mixed among devices 110 containing accelerometers. Devices 110 of the same or different types may have similar or dissimilar markings.

Devices 110 communicate as mentioned above through a network or an array of networks with network systems 140. In one embodiment, sensors in devices 110 measure local quantities and the measurement data from the devices 110 is sent to network systems 140 for storage or processing. Similarly, network systems 140 can send commands to devices 110, for example, for operation of actuators in devices 110. Use of measurement data from devices 110 or the effects of actuation of devices 110 may depend on the location of each device 110 and the orientation of any direction dependent sensors or actuators in each device 110. In accordance with an aspect of the invention, a configuration system 150 uses data from observation stations 160 to determine the locations and orientations of devices 110 in field 120.

Observation stations 160 may be mounted on network towers 130 and physically combined with or separated from the network equipment (not shown) employed in towers 130 for communications with devices 110. In an exemplary embodiment, each station 160 contains a camera or other imaging system 162, a mounting or pointing system 164, and a light 166 as shown in FIG. 2B. Camera 162 may include a long focus lens or telescope capable of capturing images of devices 110 within a coverage area assigned to the observation station 160. The mounting or pointing system 164 can be any system capable of pointing camera 162 at individual devices 110 and providing a measurement of the direction along which camera 162 is pointed. The direction that a camera points is sometimes referred to herein as the view angle although two angles are generally needed to define the orientation of a camera. The lighting system 166, which may be omitted in some other embodiments of the invention, can be mounted on the same mounting and pointing system 164 as camera 162 so that lighting system 166 can be pointed at a device 110 being observed. Lighting system 166 is particularly effective when used with device markings that are retroreflective, e.g., retroreflective tape or retroreflectors, because retroreflection can efficiently return light back along the incident direction to camera 162. FIG. 1 illustrates an embodiment in which four stations 160 can all capture an image of any device 110 in field 120. As described further below, view angles of two or more stations 160 to the same device 110 permits identification of the position of the device using triangulation. Further, processing of images of a device 110 can determine the identity and orientation of the device 110.

Configuration system 150 implements processes for determining position and orientation information from images of devices 110, view angles associated with the images, and known positions of stations 160. Configuration system 150 can be a computer executing image processing software or dedicated hardware containing circuits adapted to perform the required processing. Configuration system 150 may be located on site (e.g., at one or more of towers 130) and directly connected to one or more of stations 160. Alternatively, configuration system 150 could be remote from field 120 and communicate with stations 160 via the network or networks employed for communication with devices 110 or via another communication system. FIG. 1 illustrates configuration system 150 as being separate from network systems 140. However, configuration systems 150 could simply be a part of network systems 140 that performs configuration processes.

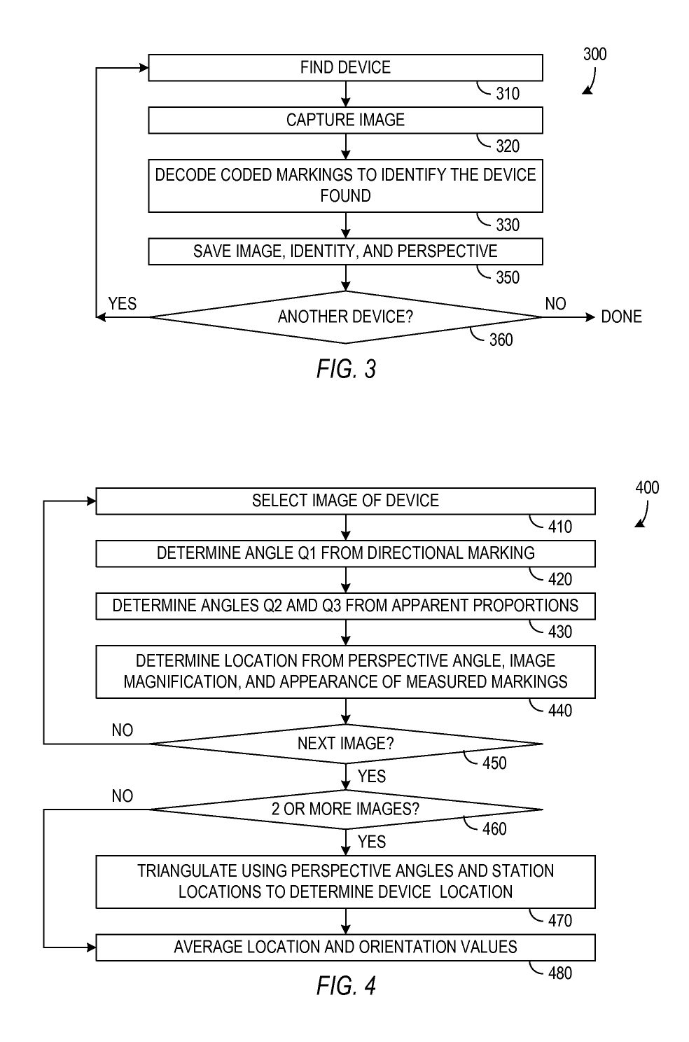

FIG. 3 is a flow diagram of a process 300 that an observation station can employ to capture images of a large number of devices in the field. An example system in which process 300 can be employed is system 100 of FIG. 1 and is described here to provide an example embodiment of process 300. Station 160 can perform process 300 under control of configuration system 150 or as an independent operation. Initially, a station 160 in step 310 finds a device 110 in field 120. Finding a device can, for example, be conducted by a systematic search that steps the object area of a camera in station 160 in overlapping steps to cover an area assigned to a station. An image can be captured in step 320 at each position of the camera or only at positions where the surface of a device 110 is recognized, for example, using conventional pattern recognition technology. In some embodiments, capturing an image of a device 110 can involve shifting the view angle of the camera to better center on a located device 110 or increasing the magnification of the camera before capturing an image. The term capture is used here to cover other forms of observation of the appearance of a device 110 and includes, for example, use of a video camera that is continuously capturing images or providing a signal that may be processed. Step 330 decodes a coded marking (e.g., markings 252 of FIG. 2A) to determine the identity of a device 110. Step 330 may be performed after step 320 as illustrated in FIG. 3 or before step 320 with an image being captured for processing on the condition that no prior images of that particular device has been captured by the observation station 160 during the current configuration process 300. For any images captured for further processing, step 340 saves (e.g., stores to memory) the image captured, the identity of the device, and a measure of the camera view angle and magnification. The magnification may not be required if the position of device 110 is to be determined by triangulation. Step 360 determines whether there is another device 110 that needs to be found, i.e., the station 160 has found all devices 110 in an area assigned to that station 160. If there are more devices 110 to find, process 300 branches back to step 310 and finds the next device. If the area of the station 160 has been fully searched, process 300 is done.

Stations 160 in system 100 generally have assigned areas that overlap, and field 120 is entirely within the overlap of the assigned areas all four stations in the illustrated embodiment of FIG. 1. As a result, execution of process 300 using each of the four stations 160 can provide images of each device 110 from four different perspectives. Alternative embodiments could capture any desired number of images of a device 110 and some devices 110 may be imaged from different numbers of stations 160 depending on the overlap of the assigned areas of the stations. However, having images of a device 110 from three or more perspectives is desirable for use of convention triangulation techniques to identify the location of the device 110.

FIG. 4 is a flow diagram of a process 400 for determining the orientation of a selected device using images of markings on the device. In an example embodiment, configuration system 150 of FIG. 1 can perform process 400 during or after the observation stations 160 perform the image capture process 300 of FIG. 3. Process 400 begins with a step 410 of selecting an image of the selected device 110. Selection of an image can include identifying the device number of a device 110 in the image, which may be performed in process 300 or alternatively by having step 410 decode coded marking in a selected image. Steps 420, 430, and 440 then extract information from a single image.

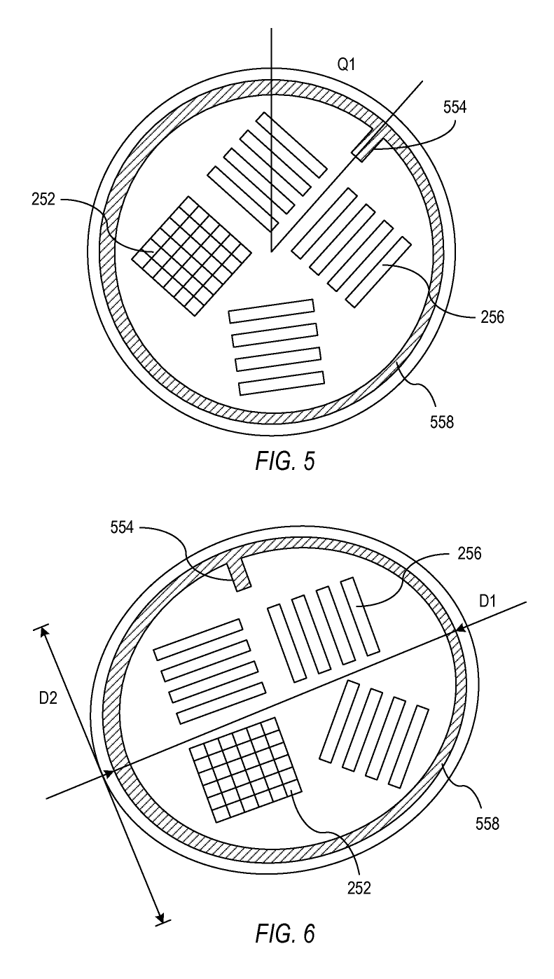

Step 420 uses the appearance of directional markings in the selected image to determine an angle Q1 that partially defines the orientation of the selected device 110. For example, FIG. 5 shows a view of markings on a device 110 captured with a view angle perpendicular to the surface on which the markings reside. A directional marking in FIG. 5 corresponds to a short stripe 554 intersecting a circular ring 558. The location of strip 554 can indicate a functional axis (e.g., a measurement axis) of the selected device. In the perpendicular perspective, the angle Q1 can be determined from an image by identifying the ratio of the length of an arc from a reference point of circle 558 (e.g., the top of circle 558) to stripe 554 and the radius of circle 558. Angle Q1 relates the rotation of the selected device about an axis extending through the center of circle 558 and along the view angle of the camera capturing the image.

Step 430 determines angles Q2 and Q3, which define the tilt of the marked surface relative to the view angle of the camera. FIG. 6 shows the markings of FIG. 5 when viewed from an angle that is not perpendicular to the plane of the markings Circle 558, which is a marking having known proportions, i.e., equal diameters in all directions, appears to have major and minor axes as a result of the marked surface being tilted relative to the view angle of the camera. The longest axis D1 corresponds to a tilt axis of the marked surface, and the ratio of the lengths of a shortest axis D2 to longest axis D1 indicates the angle of tilt about the tilt axis relative to the view angle of the camera that captured the image. The angles Q1, Q2, and Q3 can be converted to a coordinate system of the field 120 to determine pitch, yaw, and roll angles of the device in common reference frame that will also be used for other devices 110.

Step 440 determines position information for the device 110 using the view angle of the image, the image magnification, the orientation of the device 110, and the appearance of the measured markings in the image. In particular, the view angle gives the angular coordinates of a ray from the camera that captured the image to the selected device 110. Locating the device 110 just requires determination of a radial distance or coordinate relative to the known position of the observation station 160. A radial coordinate can be calculated using geometry and the size of measured markings in the image, the known actual size of the measured markings, and the magnification of the camera. Thus, the spherical coordinates with an origin at the camera can be found for position of the selected device 110. Step 440 can be omitted in favor of solely determining the position of device 110 using triangulation techniques if the configuration system is such that each device 110 will be captured in images by at least two stations 160.

Steps 420, 430, and 440 can be repeated for each image of a device to determine independent measurements of the position and orientation of the device 110. Step 450 creates a process loop for the available images associated with the devices.

Information regarding the position and orientation of the device can also be obtained from a combination of observations of the device. For example, step 460 determines whether there are at least two images of the selected device 110 from different perspectives. If so, step 470 can use triangulation based on the positions of the stations and the view angles for the three or more images to determine the position of the device. If directions from three or more stations to the device 110 are available, triangulation using the extra information can be used to improve the accuracy of the position determination. Step 480 can average (with or without weightings) information extracted from individual observations or combined observation of the selected device 110 to produce position and orientation values in a common reference frame, e.g., the coordinate system of field 120. Further, process 400 can be repeated for each device 110 in field 120, so that the positions and orientations of all devices are known and can be used in conjunction with measurements or actions of devices 110.

Some embodiments of the systems and method described above are well suited for use in the CeNSE system. With the CeNSE system a large number of devices may be deployed across large sections of the Earth. Some embodiments may deploy a trillion sensors worldwide. Because of the large number of sensors, keeping the cost of individual sensors low is critical. Some embodiments of the invention can employ a few observation stations to observe markings on devices in order to measure the position and orientation of a larger number of sensors, e.g., a million or more sensors. The field devices can use inexpensive markings to permit determination of their positions and orientations and avoid the expense of complex systems such as global positioning satellite (GPS) systems or gravity sensors to determine the devices position and orientation.

Although the invention has been described with reference to particular embodiments, the description is only an example of the invention's application and should not be taken as a limitation. Various adaptations and combinations of features of the embodiments disclosed are within the scope of the invention as defined by the following claims.

What is claimed is:

1. A device comprising:
a network interface;
a housing that contains the network interface;
markings on the housing that include a pattern and dimension that are fixed to enable determination of at least one of a position and an orientation of the device relative to a station using appearance of the markings as observed from the station.

2. The device of claim 1, wherein the markings further comprise a coded portion that identifies the device.

3. The device of claim 1, wherein the markings further comprise a directional portion indicating a direction associated with operation of the device.

4. The device of claim 3, further comprising a sensor, wherein the direction associated with the operation of the device is a measurement axis of the sensor.

5. The device of claim 1, wherein the markings further comprise a portion that is proportioned to enable identification of a tilt of the device.

6. The device of claim 1, wherein the markings comprise reflective tape that is affixed to the housing.

7. The device of claim 1, wherein the markings are retroreflective.

8. A process comprising:
operating one or more stations to capture images of a plurality of devices, wherein each of the devices has markings; and
for each device, processing one of the images of the markings of the device and using known proportions of the markings and appearance of the markings in the processed image to determine at least one of a position and an orientation of the device as deployed.

9. The process of claim 8, further comprising processing the images to determine from the markings respective identities of the devices.

10. The process of claim 8, further comprising:
operating the devices to perform measurements at deployed locations; and
communicating measurement data from the devices through a network.

11. The process of claim 8, wherein operating the one or more stations to capture images comprises detecting reflective tape on surfaces of the devices.

12. The process of claim 8, wherein image capture at each of the stations comprises:
illuminating one of the devices using light from the station; and
capturing light from retroreflective markings on the illuminated device.

13. The process of claim 8, wherein operating the stations further comprises measuring and recording view angles corresponding to the images, and wherein
the process further comprises determining the position of one of the devices using triangulation based on the view angles for two or more images of that device.

14. A system comprising:
a plurality of devices deployed in an outdoor area, wherein each of the devices has markings;
a station containing an imaging system positioned to capture images of the devices; and
a processing system coupled to receive image data from the stations, wherein the processing system is adapted to process an image of a device to measure appearance in the image of the markings of the device and to use known dimensions of the markings and measurements of the appearance of the markings to determine at least one of a position and an orientation of the device.

15. The system of claim 14, wherein each of the devices comprises a network interface.

16. The system of claim 15, wherein the devices communicate through a network including the station.

17. The system of claim 14, wherein the markings on each of the devices are reflective or retroreflective.

18. The system of claim 14, wherein:
the markings on each of the devices includes a coded portion that is unique to that device; and
the processing system is adapted to use the coded portion of the markings to determine respective identifies of the devices.

19. The system of claim 14, wherein:
the markings on each of the devices includes a directional portion; and
the processing system is adapted to use the appearance of the directional portion in an image of the markings of the device in determining respective orientations of the devices.

20. The system of claim 14, wherein:
the markings on each of the devices has a portion with proportions known to the processing system; and
the processing system is adapted to use appearance of the markings in images and the known proportions in determining respective positions or orientations of the devices.
